(19) United States
(12) Patent Application Publication
(10) Pub. No.: US 2011/0202441 A1
(43) Pub. Date: Aug. 18, 2011

(54) SMSWINCARD

(76) Inventor: Nkosi Steele, Brooklyn, NY (US)

(21) Appl. No.: 12/618,717

(22) Filed: Feb. 16, 2010

(51) Int. Cl. G06Q 20/00; G06Q 40/00; G06Q 50/00; G06Q 30/00

(52) U.S. Cl. 705/34; 705/35; 705/41

(57) ABSTRACT

The Smswincard invention revolutionizes the interactive, text based game market. Traditionally, winners of SMS sweepstakes, text-to-win sweepstakes, and respective state lottery scratch-to-win games have all purported being able to make the player an ‘instant winner’. The reality is that ‘instant win’ awards take anywhere between 6-8 weeks to be verified, processed, and actually awarded in some tangible form. Smswincard provides a means for instant verification of a winning game-piece, instant transfer of winner's account information to host, and allows for the hosts to award cash prizes immediately via wire transfer. The Smswincard platform combines cell phones, prepaid Visa debit/ATM cards, and SMS technologies to make ‘instant win’ actually instant. By combining a means of playing, a means of verifying winners, and a way to transfer and house funds, the Smswincard will be the new medium when playing any kind of ‘instant win’ game and in awarding or transferring prize money.

### CROSS-REFERENCE TO RELATED APPLICATIONS

None

### STATEMENT REGARDING FEDERALLY FUNDED RESEARCH

N/A

This invention was not made under government contract, nor was it invented as a result of federal grants or federally funded research.

### BACKGROUND OF THE INVENTION

The design of the Smswincard is unique in that it features original art in the top left corner, as well as original design in arranging the stars. The card also features a distinctive and prominent logo on the top left of the card that makes the user aware that the card has distinctive functions and features only offered by Smswincard.

### SUMMARY OF THE INVENTION

The invention solves the problem of time delay of payment when collecting prizes from participation in and from winning SMS games and prizes. The card allows the prize to be immediately transferred and uploaded into the recipient's account. The card then functions as a usual ATM card and debit card, yet is unique because its main function allows instant connection to the SMS games and sponsors that run special offers to card holders.

### DETAILED DESCRIPTION OF THE INVENTION

### a) General Explanation of the Invention and How to Practice:

The Smswincard invention ties together three technologies and processes: cell phones, SMS capability, and prepaid Visa debit card. The combination of the three gives rise to the Smswincard because it allows the user to instantly connect via SMS to the game or sweepstakes. The cardholder is able to use the prepaid Visa card as a functional ATM card for withdrawals, or debit card for purchases, never being able to exceed the limit on the card set by the available funds in the account. However, the holder of the Smswincard will be able to collect prize money awarded from playing any SMS platform based games instantly.

### b) Specific Examples of How to Practice the Invention:

i. State Lottery:

In this scenario, the state lottery has adopted the Smswincard for their scratch and win instant prize money game tickets. In order to verify a winning ticket each game piece has an identifying hidden bar code under the scratch film of the game piece containing the actual game and bar code for the piece. Using the Smswincard platform, the user would scratch the game piece to see if he was a winner and then discover the hidden bar code on the back of the game piece. He would then traditionally take the game piece, in person, to be verified before eventually receiving his award. Using the Smswincard platform, the winner could text the hidden bar code to the State Lottery award provider for instant verification. The winner would then text his Smswincard account information to the same State Lottery award provider. The award provider would instantly be able to direct deposit the winning amount in the cardholding winner's Smswincard account. The funds would then be available to him within twenty-four (24) hours of transfer for use in ATM withdrawals and/or debit card purchases. Instant win redefined: win, verify, get paid! Smswincard makes it that simple.

ii. Text-to-Win Television/Radio SMS Sweepstakes:

As in Fox's American Idol or Bravo's Top Chef, or every day on the radio, the viewing or listening audience is often invited to enter a text survey to win a certain prize. The Smswincard platform allows the hosts of these SMS sweepstakes to immediately and directly award prizes to the sweepstakes winner. The player texts his entry, and receives confirmation of his winning via text. He then has the option of receiving payment via his Smswincard account. If the winner of the text-to-win sweepstakes has an Smswincard and selects this option, he can immediately get his account information to the award provider via text message and have the prize money amount wire transferred immediately to his Smswincard account. The cardholder will then have access to the prize within 24 hours of transfer for ATM withdrawal and debit card purchase.

### SEQUENCE LISTING

N/A

1. Smswincard—a prepaid credit card device;

2. A device comprising:
a) credit card
a. prepaid, re-loadable, refillable;
b. ability for continual use;
c. allows the user to use for debit purchases;
d. allows user to make ATM withdrawals;
e. graphic design, logo, or imprint of brand/sponsor
f. issued by licensed prepaid credit card issuer;

3. The Method of use for the device outlined in claims 1 & 2 is a paperless Mobile platform which allows users to instantly collect sums of prize money won by users participating via cell phone or internet in text message games and sweepstakes or text-to-win games;

4. The Method of use for the device outlined in claims 1 & 2 allows for instant, paperless, international distribution of prize money won directly to customer's device via electronic funds transfer;

5. The method of use for the device outlined in claims 1 & 2 allows companies and brands to interact with consumers via SMS sweepstakes or text-to-win games;

6. A Process or Method for using device outlined in claims 1 & 2:
a) Prepaid credit card device charges the user a one-time activation fee;
b) Prepaid credit card device charges the user a per purchase fee with a maximum charge ceiling set for the month;
c) Prepaid credit card device charges the user a non-activity fee if the card is not used for ATM withdrawal, debit purchase, or SMS game play for 60 days;
d) Prepaid credit card device charges the user processing fees for being able to receive prize money and credit appropriate accounts with their winnings;
e) Prepaid credit card device charges no annual, monthly, or customer service fees

7. A Process or Method for using device outlined in claims 1 & 2:
a. Prepaid credit card device charges the user a one-time activation fee;
b. Prepaid credit card device is used to purchase lottery tickets, instant win sweepstakes, to participate in SMS or interne sweepstakes that have chosen Smswincard as its platform to verify winners and award prizes instantly.
c. Prepaid credit card device is used by winner of game to verify his winning game ticket
d. Host of sweepstakes distributes award to winners via instant wire transfer to Smswincard account
e. Card holder uses the Smswincard for ATM withdrawal or debit purchase
